(19) United States
(12) Patent Application Publication
(10) Pub. No.: US 2004/0050889 A1
(43) Pub. Date: Mar. 18, 2004

(54) Cargo management system useful as a table

(76) Inventors: Russell P. Shafer, Jr., Howell, MI (US); Martin Burke, Howell, MI (US); Robin Hoot, South Pasedena, CA (US); Richard N. Svenson, Northville, MI (US); Christopher Gattis, Livonia, MI (US)

Correspondence Address: Robin W Asher, Clark Hill, 500 Woodward Avenue, Suite 3500, Detroit, MI, 48226-3435, US

(21) Appl. No.: 10/380,183

(22) PCT Filed: Sep. 10, 2001
(86) PCT No.: PCT/US01/28282

(51) Int. Cl. B60R 7/00; B60R 9/00; B60R 11/00

(52) U.S. Cl. 224/403; 224/499; 224/497; 224/539

(57) ABSTRACT

The cargo management device (24) includes a frame having a pair of parallel support beams extending between a first and second end. The frame may be made of multiple frame portions that are attached to each other using hinges or other like mechanisms. The frame also has a plurality of cross beams extending between the pair of parallel support beams. A plurality of securing devices allows articles to be attached or secured to the frame between the frame and the vehicle floor (18). The cargo management device (24) also includes an attachment mechanism attaching the frame to the two opposing sidewalls (12,14) of the motor vehicle spaced apart from the vehicle floor (18) so that the articles being stored may he suspended from the frame or organized using netting and the like.

### BACKGROUND ART

1. Field of the Invention

This invention relates generally to a cargo management device for a motor vehicle. More particularly, this invention relates to a cargo management device for subdividing, organizing, supporting and retaining articles in the cargo area of a motor vehicle.

2. Description of the Related Art

Motor vehicles, including sport utility vehicles, vans, station wagons and hatchbacks offer large interior cargo areas for loading, storing, supporting and transporting various articles within the motor vehicle. The cargo area is typically defined by a load floor extending between the back side of the rearward-most seat assembly and hatch of the vehicle and between opposing lateral interior side walls of the vehicle. However, organizing and retaining articles within a large cargo area is quite difficult.

Several types of accessories have been employed to assist in organizing, stabilizing and retaining articles with the cargo area. For example, U.S. Pat. No. 5,683,132 discloses a box-type cargo liner made of flexible, semi-rigid material such as ABS plastic which easily slides into and out of the cargo area for supporting and hauling articles in the vehicle and for protecting the cargo area from damage.

U.S. Pat. No. 4,540,213 discloses another type of cargo area organizer including a plurality of parallel slats, which normally serve as cargo skids, extending longitudinally from the hatch of the cargo area and hinged to the load floor. The free ends of the slats are interconnected by a transverse cross-rail to define a rack, which may be pivoted upwardly and secured in a canted position to the sidewalls of the motor vehicle. The rack, in the canted position, defines a plurality of cargo receiving spaces for maintaining articles placed in the rack in an upright position during operation of the motor vehicle. The cargo storage accessory devices of the prior art and those set forth above are limited in their versatility and stowage capability within the cargo area of the vehicle.

### SUMMARY OF THE INVENTION

A cargo management device subdivides a cargo area of a motor vehicle defined between two opposing sidewalls and above a vehicle floor interconnecting the two opposing sidewalls. The cargo management device includes a frame having a pair of parallel support beams extending between a first and second end. The frame also has a plurality of cross beams extending between the pair of parallel support beams. A plurality of securing devices allows articles to be attached or secured to the frame between the frame and the vehicle floor. The cargo management device also includes an attachment mechanism attaching the frame to the motor vehicle spaced apart from the vehicle floor.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a partial perspective view of a vehicle cargo area and cargo management device in a use position according to the invention;

FIG. 2 is a top perspective view of one embodiment of the invention;

FIG. 3 is a perspective view of one embodiment of the invention in a folded position;

FIG. 4 is a bottom perspective view of one embodiment of the invention and a storage case;

FIG. 5 is a perspective view of one embodiment of the invention secured to the rear of the motor vehicle and supporting the storage case for use as a table;

FIG. 6 is a partially exploded view of the attachment between one embodiment of the invention and the rear of the motor vehicle; and

FIG. 7 is a perspective view of an alternative embodiment of the invention as used as a stand-alone table.

### DETAILED DESCRIPTION OF THE PREFERRED EMBODIMENTS

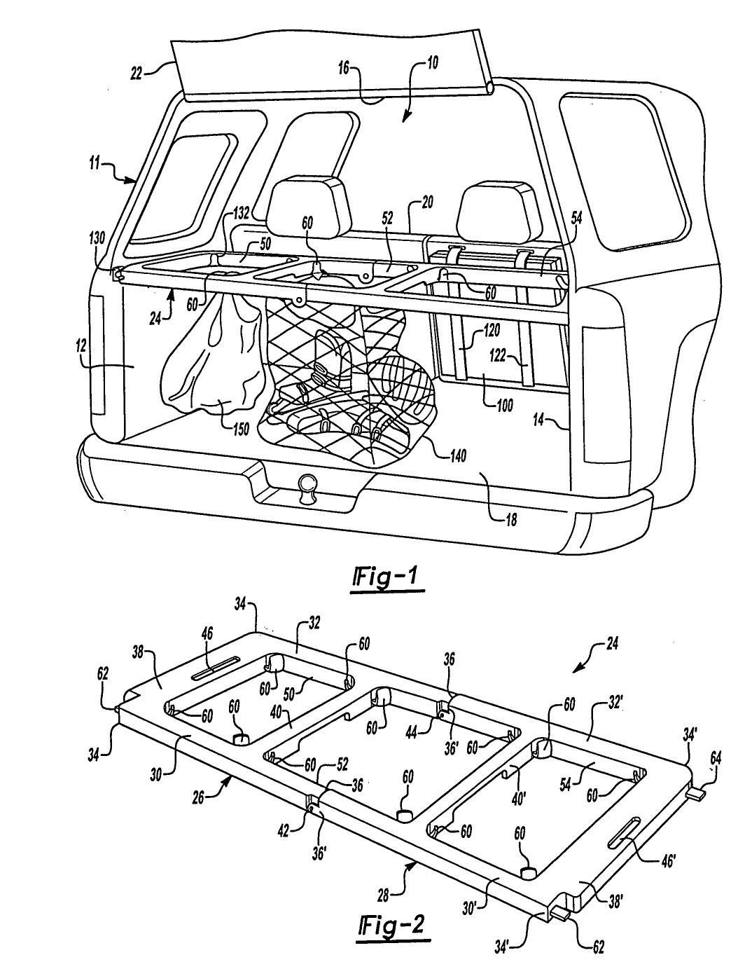

Referring to FIG. 1, a rear cargo area of a motor vehicle 11, such as a sport utility vehicle (SUV), van, or station wagon, is generally indicated at 10. The rear cargo area 10 is generally rectangular in shape and defined by spaced apart vertical sidewalls 12, 14 on either side of the motor vehicle 11 that are interconnected by spaced apart horizontal walls 16, 18. The upper wall 16 is typically known as the roof 16, and the bottom wall is typically known as the floor 18. The cargo area 10 is further defined between the rear portion of a rear seat back 20 and a tailgate, or lift gate, 22 of the vehicle to enclose the area 10.

The invention, a cargo management device generally indicated at 24, is removably attachable between each of the sidewalls 12, 14 of the motor vehicle 11. In FIG. 1, the cargo management device 24 is spaced above the floor 18 in a cargo management position.

Referring to FIG. 2, the cargo management device 24 includes a ladder-type frame construction having symmetrical frame halves 26, 28. The first half 26 includes a pair of spaced apart and parallel support beams 30, 32 extending longitudinally between first and second ends 34, 36. In the embodiment shown, two cross beams 38, 40 extend between the support beams 30, 32. The first crossbeam 38 is an end beam that creates a U-shaped frame of the support beams 30, 32 and the first end beam 38. The end beam 38 extends between the two first ends 34 of the support beams 30, 32. Although not necessary, the two cross beams 38, 40 are parallel to each other and perpendicular to the support beams 30, 32. It should be appreciated by those skilled in the art that there may be any number of cross beams extending between the first and second ends 34, 36 for adding structural rigidity to the cargo management device 24.

The second half 28, wherein like primed numerals represent similar structures in the first half 26, includes a pair of spaced apart and parallel support beams 30′, 32′ extending longitudinally between first and second ends 34′, 36′. A cross or end beam 38′ interconnects the first ends 34′ of the support beams 30′, 32′ forming a generally U-shaped second half 28. A cross beam 40′ extends generally perpendicular to and interconnects the support beams 30′, 32′ between the first and second ends 34′, 36′ for adding structural rigidity to the cargo management device 24.

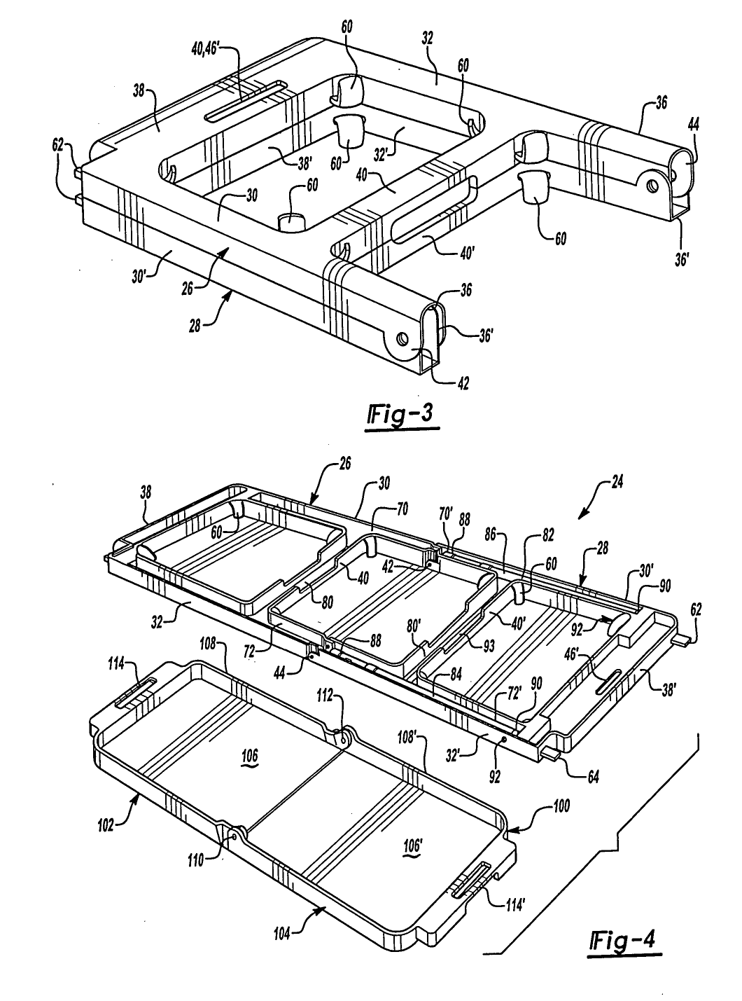

The cargo management device 24 further includes a pair of hinge mechanisms 42, 44, such as a pivot pins, pivotally interconnecting the second ends 36 of the support beams 30, 32 to the second ends 36′ of the support beams 301, 32′, respectively. The hinge mechanisms 42, 44 allow the cargo management device 24 to be fully extended to a full frame position, shown in FIGS. 1 and 2, or to a folded position with the first half 26 overlying the second half 28, as shown in FIG. 3. The hinge mechanism 42, 44 may include a locking mechanism for locking the cargo management device 24 in the full frame position or the folded position.

Further, an elongated slot 46, 46′ is formed in each of the end beams 38, 38′ between the support beams 30, 32, 30′, 32′, respectively, for providing a handle to carry the cargo management device 24 in the folded position.

As shown in FIG. 2, when the cargo management device 24 is hinged or pivoted to the full frame position, the first and second halves 26, 28 are aligned longitudinally and the beams define a plurality of frame openings 50, 52, 54. As may be seen from the embodiment shown in the Figures, the frame openings 50, 52, 54 are generally rectangular in shape. The shapes of the frame openings 50, 52, 54 may vary depending on the orientations of the beams.

Still referring to FIGS. 2 and 3, the cargo management device 24 further includes a plurality of hooks 60 projecting into the openings 50, 52, 54. More specifically, as shown in FIG. 2, a hook 60 extends from each corner portion of each opening 50, 52, 54 formed or defined by the intersection of the cross beams 38, 38′, 40, 40′ with the support beams 30, 30′, 32, 321. The hooks 60 will be discussed in greater detail subsequently.

Still further, the cargo management device 24 includes a pair of attachment pins 62, 64 projecting longitudinally from the outside portion of each support beam 30, 30′, 32, 32′ for securing the cargo management device 24 to the cargo area 10 as will be described in greater detail below.

Referring now to FIG. 4, the underside of the cargo management device 24 is shown. Each of the beams 30, 30′, 32, 32′, 38, 38′, 40, 40′ have a generally U-shaped cross-section and each half 26, 28 is formed as an integral one-piece frame member typically of molded plastic. Each of the elongated support beams 30, 30′, 32, 32′ form or define an elongated channel 70, 70′, 72, 72′. Similarly, each of the cross beams 40, 40′ form or define an elongated cross channel 80, 80′. A leg support frame 82 is recessed within the channels 70′, 72′ and cross channel 80′ of the second half 28 as shown in FIG. 4. Specifically, the leg support frame 82 includes pair of upright main legs 84, 86 extending longitudinally between a first telescoping end 88 and a second distal end 90. The distal ends 90 are pivotally coupled by pins 92 to the support beams 30′, 32′ within the channels 70′, 721, respectively. The main legs 84, 86 are interconnected by a cross leg 93 recessed with the channel 80′. It should be appreciated that the leg support frame 82 may be recessed within the channels 70, 72 and cross channel 80 of the first half 28 or a leg support frame 82 may be coupled and recessed within each half 26, 28 of the cargo management device 24 without varying from the scope of the invention.

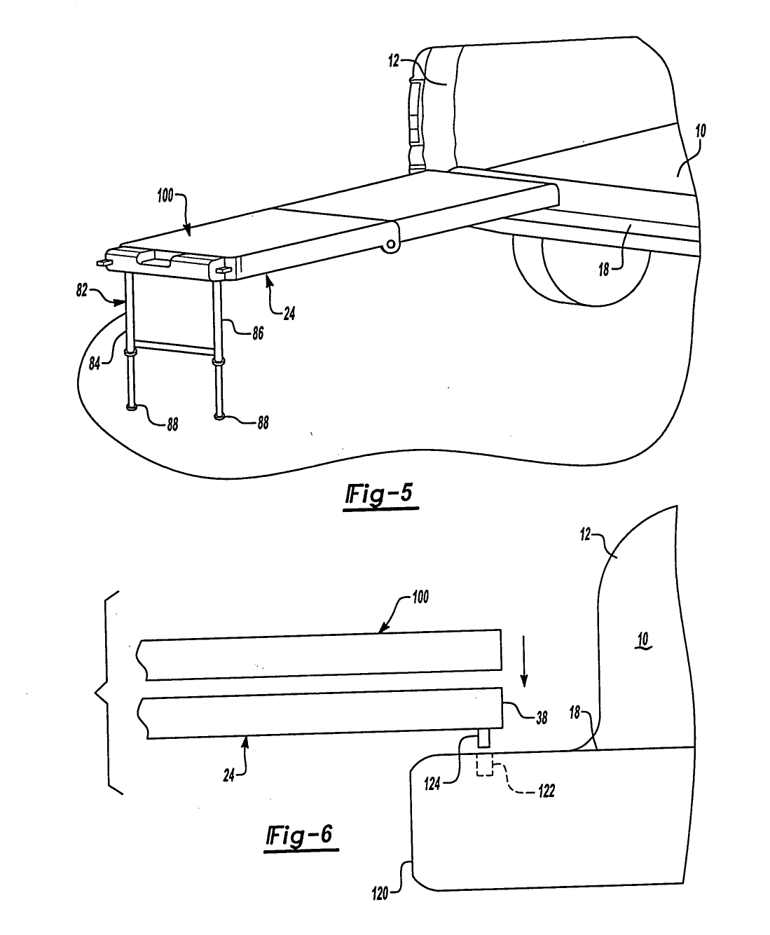

The leg support frame 82 may be pivoted about the support beams 30′, 32′ from a stowed position recessed within the channels, as shown in FIG. 4, to an upright support position extending generally perpendicular from the beams 30′, 32′, as shown in FIG. 5, for supporting the halves 26, 28 in a generally horizontal and planar position, as will be further discussed below. The first telescoping ends 88 are slidably adjustable along the main legs 84, 86 to provide vertical adjustment of the leg support frame 82 when supporting the frame halves 26, 28 in a horizontal position.

A storage case 100 is also shown in FIG. 4. The storage case 100 includes a first half 102 and a second half 104 each having a planar surface 106, 106′ surrounded by an upstanding border surface 108, 108′ defining a clam-shell type case. The upstanding border surfaces 108, 108′ are hingedly connected by pivot pins 110, 112 for hinging the first and second halves 102, 104 of the case 100 between an open position, as shown in FIG. 4, and a closed position as shown in FIG. 1. Each of the halves 102, 104 further includes a carrying handle 114, 114′ projecting transversely from the border surfaces 108, 108′, respectively, for carrying the case 100 in the closed position. The length and width defined by the upstanding border surfaces 108, 108′ when the case 100 is in the open position is slightly larger than the overall length and width of the cargo management device 24 is the full extended position so that the cargo management device 24 may be received within the case 100 and stowed therein. Specifically, the cargo management device 24 may be placed within the case 100 such that the first and second halves 26, 28 are supported on the planar surfaces 106, 106 of the first and second halves 102, 104 of the case 100, respectively. The hinge mechanisms 42, 44 of the cargo management device 24 will align with the pivot pins 110, 112 of the case 100, such that when the case 100 in pivoted to the closed position, the cargo management device 24 is pivoted to the folded position therein. The case 100 and device 24 may then be stowed with the cargo area 10 of the vehicle by the floor 18 or secured to the seat back 20 by straps 120, 122, as shown in FIG. 1.

In use, referring again to FIG. 1, the cargo management device 24 may be removably secured between the sidewalls 12, 14 of the cargo area 10 and supported thereby above the vehicle floor 18. The attachment pins 62, 64 are matingly received and secured within attachment receptacles 130, 132 on the side walls 12, 14. The receptacles 130, 132 may be those used for securing a cargo area cover as is commonly known to one skilled in the art. The cargo management device 24 provides a support frame or structure for supporting various articles in an upright position between or within the openings 50, 52, and 54 in the cargo area. Additionally, the hooks 60 may be used for supporting a cargo netting 140, or bags 150, such as grocery bags. This allows articles, shown as sporting equipment in FIG. 1, to be suspended from the cargo management device 24 or organized by the cargo netting 140 that depends therefrom.

The cargo management device 24 may also be removed from attachment between the sidewalls 12, 14 and hinged to the folded position for storage within the case 100, or independently of the case 100. The cargo management device 24 and case 100 may be stowed on the floor 18, or against the seat back 20 in the cargo area as shown.

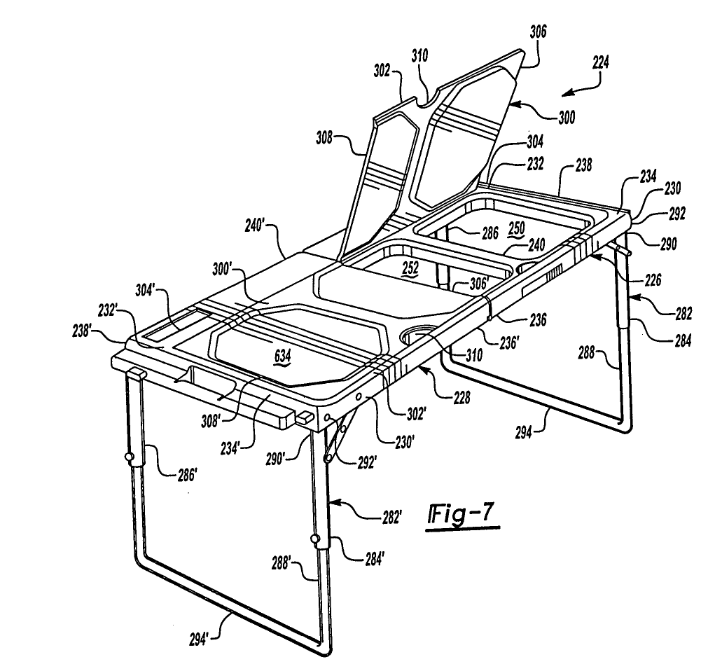

Alternatively, referring to FIG. 5, the cargo management system 24 can be removed from the cargo area 10 and placed into a table configuration. For use as a table, the cargo management device 24 is removed from the cargo area 10 and one of the end beams 38, 38′ is supported on the bumper or floor 18 of the vehicle, as shown in FIG. 5. The cargo management device 24 projects outwardly and generally horizontally from the floor 18 above the ground adjacent the vehicle. The leg support frame 82 is then pivoted from its recessed position to its upright support position extending generally vertically from the bottom of the cargo management device 24 with the support ends 88 of the legs 84, 86 supported on the ground. The case 100 may be hinged to the open position and supported on top of the cargo management device 24 to form a flat table surface extending from the vehicle. Referring to FIG. 6, the cargo management device 24 has an attachment means for securing the end beam 38 to the vehicle bumper or floor 18 and prevent incidental disengagement therefrom. Specifically, the bumper of the vehicle, shown at 120, includes a recessed cylinder 122 for receiving a cylindrical nub 124 projecting from the end beam 38 of the cargo management device 24 for supporting and securing the cargo management device 24 on the bumper 120. The case 100 is then supported on top of the cargo management device 24 to provide a planar table as shown in FIG. 5.

An alternative embodiment of a cargo management device 224 is shown in FIG. 7. The cargo management device 224 integrates the ladder type frame construction and the storage case by interconnecting the storage-case to the frame or molding the device 224 as a one-piece member. The cargo management device 224 includes a ladder-type frame construction having symmetrical frame halves 226, 228. The first half 226 includes a pair of spaced apart and parallel support beams 230, 232 extending longitudinally between first and second ends 234, 236. One cross beam 238 is configured as an end beam and is interconnected between the first ends 234 of the support beams 230, 232 forming a generally U-shaped first half 226. Another cross beam 240 extends generally perpendicular to and interconnects the support beams 230, 232 between the first and second ends 234, 236 for adding structural rigidity to the device 224. The second half 228 similarly includes a pair of spaced apart and parallel support beams 230′, 232′ extending longitudinally between first and second ends 234′, 236′. A cross or end beam 238′ is interconnected between the first ends 234′ of the support beams 230′, 232′ forming a generally U-shaped second half 228. And another cross beam 240′ extends generally perpendicular to and interconnects the support beams 230′, 232′ between the first and second ends 234′, 236′ for adding structural rigidity to the device 224. The intersection of the support beams 230, 230′, 232, 232′ with the cross beams 240, 240′ and end beams 238, 238′ create a plurality of generally rectangular frame openings 250, 252, 254.

The underside of the cargo management device 224 is similar in design to the first embodiment as shown in FIG. 4. Leg support frames 282, 282′ may be recessed against the underside of the respective halves 226, 228. As both leg support frames 282, 282′ are identical, support frame 282 will be described. Specifically, referring to FIG. 7, the leg support frame 282 includes pair of upright main legs 284, 286 extending longitudinally between a first telescoping end 288 and a second distal end 290. The distal end 290 is pivotally coupled by pins 292 to the support beams 230, 232, respectively. The leg support frames 282, 282′ may be pivoted about the support beams 230, 232 from a stowed position recessed against the underside of the halves 226, 228, to an upright support position extending generally perpendicular from the beams 230, 232 for supporting the halves 226, 228 in a generally horizontal and planar position, as shown in FIG. 7, and as will be further discussed below. The first telescoping ends 288 are interconnected by a cross leg 294 for providing further stability. Furthermore, the telescoping ends are slidably adjustable along the main legs 284, 286 to provide vertical adjustment of the leg support frame 282 when supporting the frame halves 226, 228 in a horizontal position.

Covers 300, 300′ are also shown in FIG. 7. Each cover 300, 300′ is rotationally connected to the support beam 232, 232′ and is supported by the opposing support beam 230, 230′ as well as the end beams 238, 238′ and cross beams 240, 240′. More specifically, the cover 300 is generally planer and rectangular in shape and comprises front and rear edges 302, 304 and side edges 306, 308. The covers 300, 300′ are rotationally connected along the rear edges 302, 304 to the support beam 232, 232′, respectively, by a hinge mechanism, such as a piano hinge. The covers 300, 300′ further have an arcuate shaped opening 310, 310′ along the front edge 302, 304 which act as a handle for lifting the covers 300, 300′ to provide access to the openings 250, 252, 254. It should be appreciated that the openings 310, 310′ can be a variety of configurations, such as a rigid loop, tether strap, or button pull, so as to achieve a handle function without varying from the scope of the invention.

In use, referring again to FIG. 1, the cargo management device 224 may be removably secured between the sidewalls 12, 14 of the cargo area 10 as described in the first embodiment. Referring now to FIG. 7, the device 224 provides a support frame or structure for supporting various articles in an upright position between or within the openings 250, 252, 254 in the cargo area. In order to access the openings 250, 252, 254, the covers 300, 300′ must first be rotated into an open position.

Alternatively, referring to FIG. 7, the cargo management system 224 can be removed from the cargo area 10 and placed into a table configuration. For use as a table, the device 224 is removed from the cargo area 10 and the leg support frames 282, 282′ are then pivoted from their recessed position to their upright support position extending generally vertically from the bottom of the device 224 with the support ends 288 of the legs 284, 284′, 286, 286′ supported on the ground. This forms a flat table surface, which is free standing from the vehicle.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

1. A cargo management device for subdividing a cargo area defined between two opposing side walls and above a vehicle floor interconnecting the two opposing side walls, said cargo management device comprising:
a frame including a pair of parallel support beams extending between a first and second end, and a plurality of cross beams extending between said pair of parallel support beams;
a plurality of securing devices for securing articles to said frame between said frame and the vehicle floor; and
an attachment mechanism attaching said frame to the motor vehicle spaced apart from the vehicle floor.

2. A cargo management device as set forth in claim 1 wherein said frame includes first and second frame portions.

3. A cargo management device as set forth in claim 2 including a hinge extending between said first and second frame portions allowing said first frame portion to pivot over said second frame portion.

4. A cargo management device as set forth in claim 3 wherein each of said plurality of securing devices includes a plurality of hooks.

5. A cargo management device as set forth in claim 4 wherein said attachment mechanism is an attachment pin that extends out of said frame for matingly engaging the motor vehicle.

6. A cargo management device as set forth in claim 5 wherein said frame includes a plurality of attachment pins for engaging the motor vehicle to support said frame in spaced relation above the vehicle floor.

7. A cargo management device as set forth in claim 6 including legs extendable out from said frame to engage ground allowing said frame to operate as a table structure.

8. A cargo management device as set forth in claim 7 including netting to be secured to said plurality of hooks, said netting used to retain the articles therein.

9. A cargo management device for subdividing a cargo area defined between two opposing side walls and above a vehicle floor interconnecting the two opposing side walls, said cargo management device comprising:
a frame including a pair of parallel support beams extending between a first and second end, and a plurality of cross beams extending between said pair of parallel support beams;
a plurality of securing devices for securing articles to said frame between said frame and the vehicle floor; and
a plurality of attachment pins extending out of said frame for matingly engaging the two opposing sidewalls of the motor vehicle along the two opposing sidewalls such that said frame extends across the cargo area spaced apart from and above the vehicle floor.

10. 10. A cargo management device as set forth in claim 9 wherein said frame includes first and second frame portions.

11. A cargo management device as set forth in claim 10 including a hinge extending between said first and second frame portions allowing said first frame portion to pivot over said second frame portion.

12. A cargo management device as set forth in claim 11 wherein each of said plurality of securing devices includes a plurality of hooks.

13. A cargo management device as set forth in claim 12 including legs extendable out from said frame to engage ground allowing said frame to operate as a table structure.

14. A cargo management device as set forth in claim 13 including netting to be secured to said plurality of hooks, said netting used to retain the articles therein.

15. A cargo management device for supporting various articles within a cargo area of a vehicle, the cargo area defined between opposing spaced apart side walls interconnected by a vehicle floor, said cargo management device comprising:
a first frame half having a pair of spaced apart and parallel support beams extending longitudinally between first and second end and an end beam interconnecting said first ends defining a generally U-shaped first frame half;
a second frame half having a pair of spaced apart and parallel support beams extending longitudinally between first and second ends and an end beam interconnecting said first ends defining a generally U-shaped second frame half;
an attachment mechanism extending longitudinally from said end beams of each of said first and second frame halves for removably attaching said device between the side walls and spaced above the vehicle floor; and
a pair of hinges pivotally interconnecting said second ends of said support beams of said first frame half to said second ends of said support beams of said second frame half for providing pivotal movement of said device between a full frame position with said first frame half aligned longitudinally with said second frame half for attachment between the side walls of the vehicle and a folded position with said first frame half overlying said second frame half for storage within the cargo area of the vehicle.
